(19) United States
(12) Patent Application Publication
(10) Pub. No.: US 2024/0247579 A1
(43) Pub. Date: Jul. 25, 2024

(54) Methods and Devices for Introducing Drilling Channels in the Ground

(71) Applicant: TRACTO-TECHNIK GmbH & Co. KG, Lennestadt (DE)

(72) Inventors: Ferdinand FUNKE, Finnentrop (DE); Andreas HANSES, Lennestadt (DE); Tobias KLEIN, Lennestadt (DE); Elmar KOCH, Eslohe (DE); Thomas SCHAUERTE, Lennestadt (DE)

(73) Assignee: TRACTO-TECHNIK GmbH & Co. KG, Lennestadt (DE)

(21) Appl. No.: 18/490,366

(22) Filed: Oct. 19, 2023

(30) Foreign Application Priority Data
Oct. 21, 2022 (EP) 22203146.0

(51) Int. Cl. E21B 44/00; E21B 47/09; G08B 21/18

(52) U.S. Cl. CPC E21B 44/00; E21B 47/09; G08B 21/18

(57) ABSTRACT

The invention relates to a method for introducing a boring channel in the ground by means of an earth boring device, wherein the earth boring device has a boring head which is moved to introduce the boring channel in the ground, and the method comprises the steps: a) detecting obstacles in front of and/or next to the boring head; b) displaying the position of a detected obstacle relative to the boring head; c) issuing a shutdown warning if the distance between the detected obstacle and the boring head is less than a first, in particular selectable, distance; d) stopping boring of the boring channel when a shutdown warning is issued; e) verifying an acknowledgment for continued introduction of the boring channel when a shutdown warning has been issued and boring stopped; and f) continuing the introduction of the boring channel upon successful verification of the acknowledgment.

The invention relates to a method for introducing a boring channel in the ground by means of an earth boring device, a computer program product comprising instructions which, when the program is executed by a computer, cause the computer to perform the method, a computer-readable data carrier on which the computer program product is stored, and an earth boring device for introducing a boring channel in the ground.

It is known to use earth boring devices to make earth bores or boring channels in the earth.

Obstacles in the region of the boring channel to be created pose a problem. These obstacles may be hard rock fragments that cannot be crushed by the earth boring devices used, or water, gas, electricity, signal and/or other lines or channels.

For example, a boring head of an earth boring device is known from DE 10 2008 026 456 A1, which has a housing and a radar unit arranged inside the housing. The radar unit generates electromagnetic waves that emerge from the housing. By receiving these waves after they have been reflected by an object, it is possible to calculate the distance, shape, size and position of the object. Automatic or manual avoidance of the obstacle(s) can be realized by appropriate control of a drive unit.

Even if automatic bypassing is possible by means of steerable devices, the challenge remains, especially for earth boring devices that are not steerable to a sufficient extent or essentially non-steerable earth boring devices, regarding how to react to an obstacle in the planned boring channel and its surroundings. It is known to perform an emergency shutdown when an obstacle is detected in the region of the planned or driven boring channel.

Although such systems and such a method achieve good results, it has been found in the context of the invention that in certain cases the automatic deflection from obstacles or the emergency shutdown of the earth boring device are designed too “conservatively”. This can unnecessarily increase the time required for introducing the boring channel.

Accordingly, it is the object of the present invention to create a method, a computer program product, a computer-readable data carrier and an earth boring device with which a faster and/or optimized introduction of the boring channel in the ground can be made possible, which can mean a clear added value for the user of an earth boring device.

The task is solved by the subject matter of the independent claims. Advantageous embodiments are the subject of the respective dependent claims and the description.

The core idea of the invention is to pursue an approach which at first appears to be contradictory, in that, despite a possible “emergency shutdown”, the user is put in the position to decide whether the boring channel should continue to be bored despite the “emergency shutdown”. Whereas in the prior art the earth boring device is “recovered” from the ground after an “emergency shutdown”, according to the invention a user can decide whether the planned boring channel should continue to be introduced in the ground. For this purpose, according to the invention, a safety query in the form of an acknowledgement is provided, indicating that the “emergency shutdown” has been acknowledged by the user, but by a representation of obstacles in the region of the boring channel, the user can decide whether the further introduction of the boring channel is possible despite the shutdown by the control system. A qualified input in the form of an acknowledgement of the “emergency shutdown” or shutdown warning can be used to resume or continue introduction of the boring channel. The user is provided with a decision-making aid in the form of the representation of the obstacles in the ground, which can enable the user to make a decision as to whether and/or, as the case may be, how further introduction of the boring channel is possible.

The invention provides a method for introducing a boring channel in the ground by means of an earth boring device. The earth boring device comprises a boring head which is moved for introducing the boring channel in the earth. The method comprises the steps of: a) detecting obstacles in front of and/or next to the boring head; b) displaying a detected obstacle relative to the boring head; c) issuing a shutdown warning if the distance between the detected obstacle and the boring head is less than a first, in particular selectable, distance; d) stopping the introduction of the boring channel when a shutdown warning is issued; e) verifying an acknowledgement for continued introduction of the boring channel when a shutdown warning has been issued and introduction of the boring channel has stopped; and f) continuing introduction of the boring channel upon successful verification of the acknowledgement.

The term “earth” as used in the invention more particularly includes any type of material, including but not limited to ground, sand, rock, stone, and mixed forms thereof.

The term “boring channel” as used herein includes preferably at least sectionally horizontal, channels or boreholes existing or to be constructed, in particular earth channels including earth boring, rock boring or the like.

In the sense of the description, the term “earth boring device” comprises a (and thus any) device which can move, in particular, a boring string comprising rods in an existing or to be created channel, in particular in the earth, in order to create or widen a borehole, in particular a horizontal borehole (HD), or to draw in channel lines or other long bodies into the earth. The earth boring device may in particular be a HD device. An earth boring device may be a device driving a boring string, which may in particular displace earth. The boring string can be introduced into the earth translationally and/or rotationally in the longitudinal axial direction of the boring string. The boring string can be moved in the earth by tensile or compressive loading and, if necessary, also rotationally. The earth boring device can also be a “self-driven earth boring device”. A self-driven earth boring device is usually an earth boring device referred to as a ram drilling device or earth boring rocket. Such earth boring devices operate in an earth displacing manner. Self-propelled earth boring devices can percussively drive a channel or conduit into the earth. The self-propelled earth boring device usually has a boring head tip designed as a bit, which is arranged in a housing and can be acted upon at the end by an impact piston, wherein the boring head tip can be arranged longitudinally movable or fixed in the housing.

For the purposes of the description, the term “boring head” includes a front element with respect to the direction of advance, which is an outwardly directed or exposed end of the earth boring device located in the earth, which comes into contact with the earth during boring. The boring head forms the front portion of the earth boring device, which is the first to come into contact with the earth.

The term “detecting obstacles” includes the possibility of obstacles being detected in the earth. The use of the plural of the term “obstacle” expresses that multiple obstacles can be detected, although it is of course also possible that—particularly in the absence of an obstacle or obstacles—none of the obstacles are detected or cannot be detected.

The term “obstacle” expresses the possibility that a detection occurs that represents a response or a response signal to a detection signal. If an “obstruction” is detected, it is assumed that there may be something in the ground at the location where or for which a detection is made that could be an obstruction to a boring channel. The term “detection of an obstruction” includes a detection of an interface between the earth and a material different from the earth. The location of an interface between the earth and a material different from the earth may be detected, whereby locations of possible interfaces may be detected by progressively moving the boring head in the earth and may be combined to form an “overall picture” of detected obstacles, which may be only one obstacle, in the earth along the boring channel.

In particular, “detection of obstacles” can be achieved by means of electromagnetic waves, in that the earth boring device emits electromagnetic waves that can be reflected in the earth. The reflected waves can be detected by the earth boring device. It may be provided that the electromagnetic waves are radar waves. In this respect, a detection can be carried out by means of a detection device, which is arranged in particular on or in the boring head, in particular preferably a detection device designed as a radar unit. It can also be provided that more than one detection device is present. For example, two or more detection devices can be present on and/or in the boring head, which are arranged at a distance from one another along the longitudinal axis of the boring head, have a different range with respect to detection and/or detect obstacles at different angles.

The term “displaying the position of a detected obstacle relative to the boring head” is understood to mean a display in which the position of the detected obstacle relative to the boring head is displayed to the user in such a way that the distance of the boring head from the detected obstacle in at least one direction in space is displayed to the user. For example, it is possible that the user is presented with a view of the ground in which the boring head and the detected obstacle(s) are displayed.

The term “issuing a shutdown warning” includes notification, which may be visual, audible, and/or haptic. The user may be informed that a shutdown warning is present via one of the sensory inputs. The term “shutdown warning” includes a warning that is used to inform the user that a minimum distance from the obstacle is not or cannot be maintained during the creation of the boring channel.

The invention can also provide an added value to the user by freely selecting the value for the first distance, as previous considerations have always assumed a fixed minimum distance to the boring head and/or the boring channel. Within the scope of the invention, it was recognized that the first distance can be determined as required. This requirement-based determination initially contradicts the previous understanding of safety, which provided for exactly one minimum distance, but paradoxically opens up increased safety for the user, since, for example, when creating a pilot bore, the diameter of an expansion bore to be carried out following the pilot bore can already be taken into account. In addition to the core idea of the invention, a freely selectable distance can be used to detect already during pilot boring whether an expansion bore with an expansion head with a larger diameter than the boring head of the pilot bore enters the region of obstacles.

By taking into account a freely selectable first distance, a faster introduction of the boring channel can be made possible, since the pilot bore can already be “corrected”.

The term “first distance” refers to a distance in the form of a length. The length of the first distance can be preselected. The setting or preselection of the length may be done by means of an input from the user or a person of a selected group of persons authorized to do so.

The output and/or display may be provided at an operator station controlling the earth boring device and/or a drive unit. It may be envisaged that the output and/or display takes place on a device that can be carried by the user. It is possible that an outputting and/or displaying comprises transmitting a signal that is communicated to a central unit and/or an element in a network. Receipt of the signal may be communicated by the central unit and/or element in the network, and/or may be retrieved by the central unit and/or element in the network. The output and/or display may be uploaded to a cloud so that it may be viewed at any location.

For purposes of the description, the term “stopping the introduction of the boring channel” includes stopping the introduction of the boring channel by, for example, i) stopping the advancement of the earth boring device, ii) turning off the earth boring device, and/or iii) placing the earth boring device in a standby mode in which the earth boring device is still on but no advancement is occurring.

For purposes of the description, the term “acknowledgement” includes an input by a user that can be used to determine that a user has responded to the displayed shutdown warning in such a way that the user was required to acknowledge or approved the shutdown warning. An “acknowledgement” may be a qualified input that cannot be accidental, careless, and/or inadvertent. It may require input from a user that requires more than a single keystroke.

Continued introduction of the boring channel or resumption of introduction of the boring channel may only occur upon successful verification of the acknowledgement, so that a hurdle for continued introduction of the boring channel may be achieved, and no inadvertent restart of the earth boring device may be possible after a shutdown warning.

In a preferred embodiment, the term “pre-warning” comprises the fact, that when detecting obstacles in front of and/or adjacent to the boring head, it has been or is determined that a distance between the detected obstacle and the boring head is less than a second distance. The value for the second distance or the length specification for the second distance can be defined by the user or a group of persons authorized for this purpose. The purpose of issuing a pre-warning is to inform the user that the boring head may approach an obstacle such that there may be a critical condition in the further course of creating the boring channel; the user may be “forewarned”. It may alternatively or additionally be provided that an official administrative minimum distance to an obstacle may be specified, compliance with which must be taken into account.

Typically, the first distance may be chosen to be greater than the second distance. However, it may also be the case that the prewarning is based on a minimum distance of a boring channel for which a widening hole still has to be bored. Then the first distance could be selected smaller than the second distance, which can define the desired distance between obstacle and (“widened”) boring channel. By entering the distances, a high degree of flexibility can be ensured when introducing the boring channel.

It may also be provided that a further third distance is taken into account. For example, the first distance may indicate the necessary distance with which the creation of the boring channel is technically possible (without contact or collision with the obstacles); the second distance may relate to a minimum regulatory distance between the boring channel and the obstacle; and the third distance may correspond to a distance for a pre-warning.

In a preferred embodiment, the display of the position of a detected obstacle relative to the boring head comprises a display of multiple views. Multiple views may mean, in the sense of the description, that the position of one or more detected obstacles relative to the boring head may be displayed to the user in multiple views, in particular views aligned or arranged at an angle to each other. In particular, there may be an angle between the views that may be substantially equal to or close to 90° in a spatial direction. The views may be an image in a direction of the ground, and both the boring head and the detected obstacle(s) may be displayed. A display of the boring head per se may also be omitted if, for example, the boring head is assumed to be centered in a display or view. A schematic representation of one or more obstacles may be achieved. In a display, the boring head may be represented as a point or cross, in particular with an extent corresponding to the diameter of the boring head. The representation of one or more detected obstacles can in particular be a complete representation of the detected interfaces between ground and a material different from the ground.

In a particularly preferred embodiment, the multiple views may comprise a side view, a top view, and/or a view along the longitudinal axis of the boring channel. It may be provided that, in a pictorial representation, the scale or an information corresponding to the scale is present in the image or is represented in or at the image.

In a preferred embodiment, the display of the position of a detected obstacle relative to the boring head comprises a display of an at least two-dimensional extent of a detected obstacle, which may result in particular from the fact that the detected locations of interfaces between the ground and a material different from the ground are displayed two-dimensionally. Hereby, the user is not only informed about a distance to an obstacle, but also about a contour of possible obstacles, so that the user is enabled to decide about an acknowledgement, for example because there is an error in the detection of the obstacle or the user can decide what kind of obstacle it may be. For example, by means of the display of an at least two-dimensional extent of a detected obstacle, a channel or conduit can possibly be identified as such.

In a preferred embodiment, the acknowledgement is made by means of an alphanumeric input, a key input and/or an actuation of one or more actuating elements. It is also possible to have an acknowledgement performed via an external (e.g. mobile) device (e.g. by a supervisor) after the supervisor has received a shutdown warning, e.g. via a cloud or via an SMS etc. This can be used to define the height of the threshold for an unintentional acknowledgement. For example, the necessary alphanumeric input for acknowledgement is only known to certain users, wherein the possibility exists that the alphanumeric input can be passed on to third parties without a logging and/or in a traceable way. It can be provided that different users or different user groups are assigned an alphanumeric input, so that it can be logged which user or which user group has issued the acknowledgement in the form of the alphanumeric input. The same applies to a mechanical or electromagnetic key (e.g. a code card), which may be issued to a specific user or user group. The same may apply to an actuation of one or more actuation elements, which, for example, must be actuated in a certain sequence. In the case of actuation of a plurality of actuating elements, it may also be provided that the actuating elements must be actuated at least partially simultaneously. The manner of actuation of a plurality of actuating elements can in turn only be communicated to a specific user or group of users, so that here too it is possible to trace or log which user or group of users has performed the acknowledgement.

As explained above, the threshold level for unintentional acknowledgement can be specified. In accordance with the above exemplary acknowledgement, a biometric input for the acknowledgement may also be additionally or alternatively possible, wherein the biometric input may correspond to a key input. For example, it may be possible to recognize a fingerprint, a face, or an iris, wherein a corresponding reader or input device may be provided. The key input and the biometric input may be considered as an acknowledgement by means of an owned code.

It may be provided that, analogous to said exemplary alphanumeric input, a pattern or graphic stroke sequence may be entered alternatively or additionally, wherein the input of a pattern or graphic stroke sequence may correspond analogously to the entry of an alphanumeric input. The alphanumeric input and the input of a pattern or a graphic stroke sequence can be regarded as acknowledgement by means of a code made known to one (“knowledge” aspect).

It is also alternatively or additionally possible for an image reader to be presented with an image code to trigger an acknowledgement, which may be considered analogous to a key input. The image input or the input of an image code may also be regarded as an acknowledgement by means of the aspect “ownership”.

In a preferred embodiment, a log of displaying the position of a detected obstacle relative to the boring head and/or outputting a pre-warning and/or shutdown warning and/or acknowledgement is generated. Since continuing or resuming the introduction of the boring channel after a shutdown warning is a critical operation, it may be provided and desirable to generate a log of the creation of the boring channel with any warnings that may occur and/or an acknowledgement so that a technical malfunction can also be detected.

It may also be possible to store the log of the creation of a boring channel when no shutdown and/or pre-warning has occurred. For example, a table can be stored in which data on obstacles can be assigned to the length values of the boring channel. For example, the respective polar coordinates of obstacles can be assigned to a length of the boring channel.

In a preferred embodiment, the boring head can be moved back in the ground after a shutdown warning, and the log can be used to bypass at least one detected obstacle. In this way, an at least partially automatic embodiment can be achieved in that data from the log can be provided to the user to move the boring head around the obstacle or obstacles. In a particularly preferred embodiment, a substantially automatic reverse movement and renewed advancement of the boring head may be performed.

In a preferred embodiment, if the acknowledgement is not successfully verified, the earth boring device is moved a distance backwards out of the ground and an alignment of the earth boring device is performed in response to the detected obstacle or obstacles. It may be provided that the backward movement is performed such that the boring head remains in the earth. The boring head can then be steered in the ground to avoid the obstacle or obstacles. In particular, the alignment can be performed interactively.

Provision may also be made for the boring head to be completely retrieved from the earth. It is then possible to align the boring head or the earth device on the carriage, and the resulting boring channel can be related to the position of the detected obstacles or the position of the detected obstacle.

Based on the information provided to the user about one or more obstacles in the earth along the boring channel, for example in the form of logging relating to the position of the boring head when the boring channel is “not successfully introduced” relative to obstacles, an improved alignment of the earth boring device can be made, which can be accelerated—although the introduction of the boring channel has failed in a “first attempt”—. The earth boring device can be aligned so that a potential source of danger in the earth in the form of the detected obstacle or obstacles is outside the boring channel to be introduced. Introduction of the boring channel may become possible in a “second attempt” by aligning the carriage accordingly. Is. It may be provided that the user is provided with information on how to align the carriage in order to introduce the boring channel resulting from the alignment of the carriage at a sufficient distance from the obstacles previously detected in the ground.

In a preferred embodiment, part or all of the method is performed on a computer. It is possible that the user only has to provide the acknowledgement, refuse the acknowledgement and/or make a possible alignment of the carriage. It may also be provided that the carriage is automatically aligned with knowledge of the detected obstacles.

The invention also provides a computer program product comprising instructions which, when the program is executed by a computer, cause the computer to perform a method described herein.

The invention also provides a computer-readable medium on which the prescribed computer program product is stored.

Since earth boring devices have computers for controlling the same, the method according to the present invention may be carried out by means of feeding a computer program into the computer of the earth boring device as required. For example, it is possible for an earth boring device to be “enhanced” with the present invention, for example, in the form of a computer program product that is executed on the earth boring apparatus computer and/or a computer-readable medium that is read by the earth boring device computer to execute a corresponding program or method, and to provide added value to the user.

The invention also provides an earth boring device for introducing a boring channel in the earth, the earth boring device comprising a boring head which is moved to introduce the boring channel in the earth. The boring head comprises means for detecting obstacles in front of and/or adjacent to the boring head, wherein the earth boring device is configured to display the position of a detected obstacle relative to the boring head. A shutdown warning is issued if the distance between the detected obstacle and the boring head is less than a first, in particular selectable, distance. The earth boring device is further configured to stop the introduction of the boring channel when a shutdown warning is issued. An input for an acknowledgement for a resumption of the introduction of the boring channel is provided, wherein upon a successful check of the acknowledgement the earth boring device is configured to resume the introduction of the boring channel.

In a preferred embodiment, a display device is provided that is configured to display the position of a detected obstacle relative to the boring head and includes a display of multiple views.

In a preferred embodiment, an alphanumeric input, a key input, and/or one or more actuators are provided for acknowledgement.

In a preferred embodiment, a memory, particularly a non-volatile memory, is provided to store a log of the display of the position of a detected obstacle relative to the boring head and/or the output of pre-warning and/or shutdown warning.

The invention is described with respect to several aspects relating to a method, a computer program product, a computer readable storage medium, and an earth boring device. The explanations of the individual aspects complement each other, so that in particular the explanations of the method are to be understood as explanations of the description for the earth boring device. With the description of the method, device-side features or system-side features are also described or disclosed for the earth boring device and vice versa, so that with the description of the earth boring device, actions in the sense of the method or individual method steps of the method are also disclosed.

The term “have” in the sense of the description includes both the meaning inherent in the term that further elements can be provided in addition to the elements mentioned (non-exhaustive list), but also the meaning that the term “have” is used synonymously for “consist of” or “formed from”.

The foregoing, like the following description of exemplary embodiments, does not constitute a waiver of any particular embodiments or features.

The invention is explained in more detail below with reference to an exemplary embodiment shown in the drawing.

In the drawings, in particular:

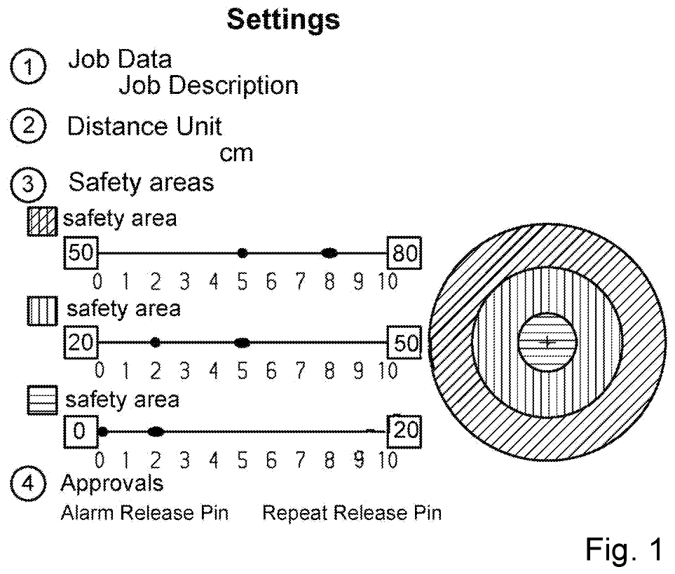

FIG. 1 shows a display for a user, with which a first distance and a second distance can be selected;

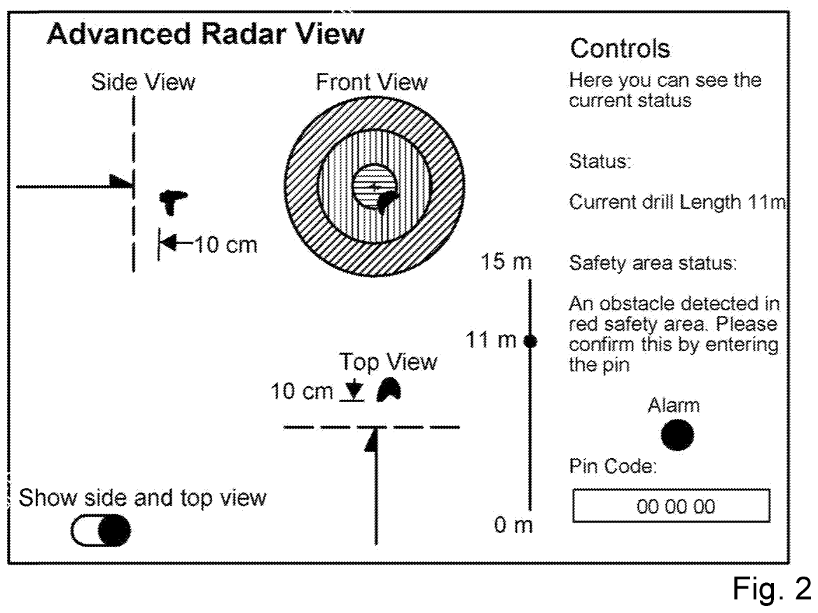

FIG. 2 shows a display for a user during introduction of a boring channel with three views including a side view, a view in the direction of the longitudinal axis of the earth boring device (a plane transverse to the longitudinal axis of the boring head), and a top view, wherein a shutdown warning has been issued;

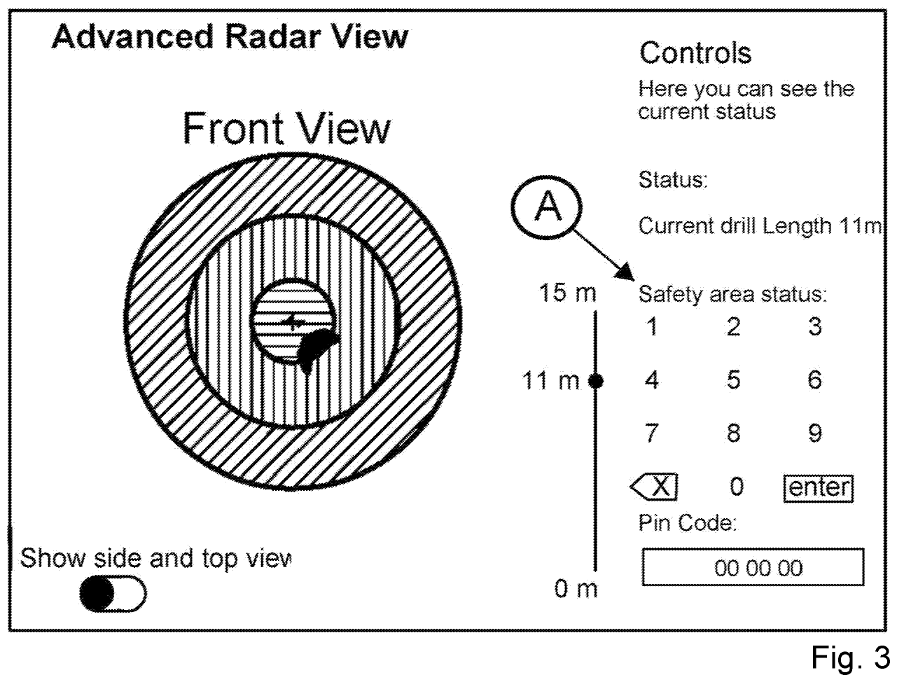

FIG. 3 shows a display to a user after introduction of a boring channel as a representation for a log; and

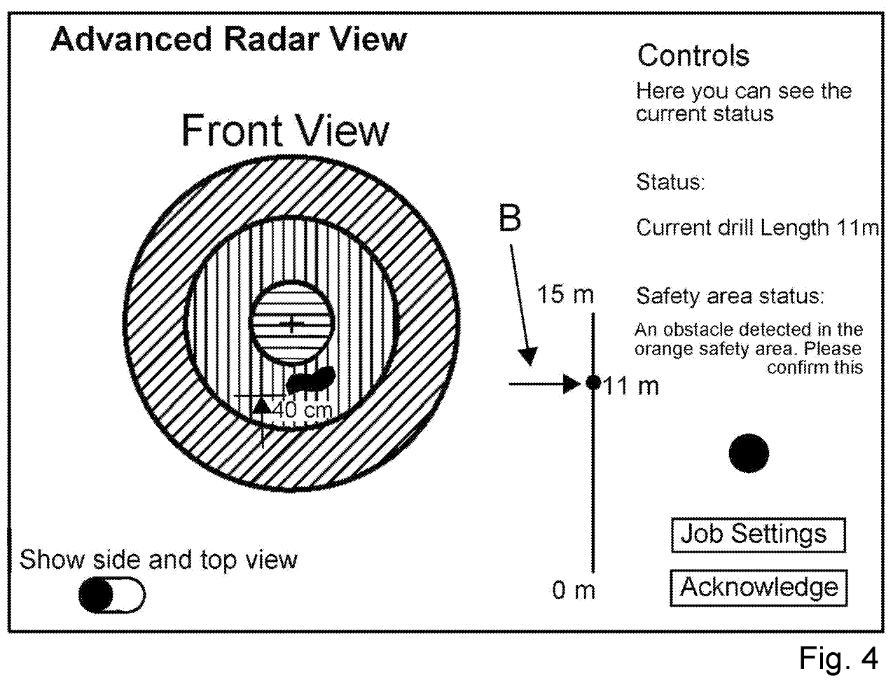

FIG. 4 shows a display for a log in which the views and warnings for a particular position of the boring head in a created boring channel are displayed for the user.

FIG. 1 shows a display for the user of an earth boring device, in which a first distance (horizontal hatching) is selected for a shutdown warning and a second distance (vertical hatching) is selected for a pre-warning. The first distance is selected smaller than the second distance.

FIG. 2 shows a view for a user when creating the boring channel with three views including a side view, a view in the direction of the longitudinal axis of the boring head (a plane transverse to the longitudinal axis of the boring head), and a top view, where a shutdown warning has been issued. An obstacle has been detected. The detected obstacle is less than the length of the first distance from the boring head, such that a shutdown warning is issued and advance of the boring head is stopped.

FIG. 3 shows, in the region indicated by a letter A in the circle, a way to make an acknowledgement in the form of a PIN entry to resume boring operation and restart the earth boring device.

FIG. 4 shows a view of a portion of a log recorded during the introduction of the boring channel into the earth. The arrow indicated by a B in the circle indicates the length or position of the boring head in the boring channel, and the views that were presented to the user during the creation of the boring head are shown. The user can run through the log saved for the creation of the borehole by moving the point in the borehole indicating the length or position of the boring head on the vertical line (actual bored length of the created boring channel).

1. A method for introducing a boring channel in the ground by means of an earth boring device, wherein the earth boring device has a boring head which is moved to introduce the boring channel in the ground, and the method comprises the steps:
a) detecting obstacles in front of and/or next to the boring head;
b) displaying the position of a detected obstacle relative to the boring head;
c) issuing a shutdown warning if the distance between the detected obstacle and the boring head is less than a first, in particular selectable, distance;
d) stopping boring of the boring channel when a shutdown warning is issued;
e) verifying an acknowledgment for continued introducing of the boring channel when a shutdown warning has been issued and the introduction of the boring channel has been stopped; and
f) continuing the introducing of the boring channel upon successful verification of the acknowledgment.

2. The method according to claim 1, wherein a pre-warning is issued when the distance between the detected obstacle and the boring head is less than a second distance, wherein the second distance is in particular greater than the first distance.

3. The method of claim 1, wherein the display of the position of a detected obstacle relative to the boring head comprises displaying multiple views.

4. The method of claim 1, wherein the display of the position of a detected obstacle relative to the boring head comprises a display of an at least two-dimensional extent of a detected obstacle.

5. The method of claim 1, wherein the acknowledgment takes place by means of an alphanumeric entry, a key entry and/or an actuation of one or more actuation elements.

6. The method of claim 1, wherein a log of the display of the position of a detected obstacle relative to the boring head and/or output of pre-warning and/or shutdown warning and/or acknowledgment is created.

7. The method of claim 6, wherein the boring head is moved back in the ground after a shutdown warning, and the log is used to avoid at least one detected obstacle.

8. The method of claim 1, wherein the method is carried out on a computer.

9. A computer program product comprising instructions which, when the program is executed by a computer, cause it to carry out a method according to claim 1.

10. A computer-readable data carrier on which the computer program product according to claim 9 is stored.

11. An earth boring device for introducing a boring channel in the ground, wherein the earth boring device has a boring head which is moved to introduce the boring channel in the ground and has a device for detecting obstacles in front of and/or next to the boring head, wherein the earth boring device is designed to determine the position of a detected obstacle relative to the boring head and to issue a pre-warning and/or shutdown warning, wherein the pre-warning is issued when the distance between the detected obstacle and the boring head is less than a first distance, and the shutdown warning is issued when the distance between the detected obstacle and the boring head is smaller as a second distance, wherein the first distance is greater than the second distance, and the earth boring device is further configured to stop the introducing of the boring channel when a shutdown warning is issued, wherein an input for an acknowledgment for a resumption of the introducing of the boring channel is provided, and if the acknowledgment is successfully verified, the earth boring device is designed to resume the introducing of the boring channel.

12. The earth boring device of claim 11, wherein a display device is provided which is designed to display the position of a detected obstacle relative to the boring head and comprises a display of multiple views.

13. The earth boring device of claim 11, wherein an alphanumeric input, a key input and/or one or more actuating elements are provided for the acknowledgment.

14. The earth boring device of claim 11, wherein a memory is present, in which a log of the display of the position of a detected obstacle relative to the boring head and/or of the issuance of pre-warning and/or shutdown warning is stored.

15. The earth boring device of claim 14, wherein a control is present by means of which the boring head is at least partially moved back and/or moved forward in an aligned manner to avoid the at least one obstacle.
